(19) United States
(12) Patent Application Publication
(10) Pub. No.: US 2025/0332800 A1
(43) Pub. Date: Oct. 30, 2025

(54) Tailored Stiffness Composite Filler Member

(71) Applicant: The Boeing Company, Arlington, VA (US)

(72) Inventors: Joseph H. Campana, Mill Creek, WA (US); Gabriel Zane Forston, Lake Stevens, WA (US)

(21) Appl. No.: 18/647,062

(22) Filed: Apr. 26, 2024

(51) Int. Cl. B29C 70/88; B29B 11/16; B29C 65/00; B29C 70/20; B29K 105/08; B29L 31/30

(52) U.S. Cl. CPC B29C 70/887; B29B 11/16; B29C 66/13; B29C 70/20; B29C 2793/0036; B29C 2793/0081; B29K 2105/0881; B29L 2031/3076

(57) ABSTRACT

A method of making a composite filler member with a tailored stiffness from a composite blank. The method includes cutting the elongated fibers within the composite blank and forming a plurality of shorter discrete fiber sections and forming the composite blank into a corrugated configuration. A composite filler material includes cut fiber sections and uncut fibers. A method of making a composite blank includes positioning the composite blank on a support surface and cutting one or more of the elongated fibers within the composite blank and reducing the initial stiffness of the composite blank to a working stiffness.

### TECHNOLOGICAL FIELD

The present disclosure relates generally to the field of composite filler members and, more specifically, to composite filler members that include elongated fibers that are cut to two or more discrete sections along the length.

### BACKGROUND

Composite structures are used in a wide variety of applications due to their high strength-to-weight ratio, corrosion resistance, and other favorable properties. In aircraft construction, composites are used in increasing quantities to form the fuselage, wings, horizontal and vertical stabilizer, and other components. For example, the wing of an aircraft may be formed of composite skin panels co-cured or co-bonded to internal composite structures such as composite stringers. The composite stringers may extend along a spanwise direction from the wing root to the wing tip.

Composite materials are tough, lightweight materials created by combining two or more functional components. For example, a composite material may include reinforcing fibers bound in polymer resin matrix. In thermoset composites, fibers and resins are arranged and cured to form a composite material. When composite structural members are joined together, gaps or voids may be present along bond lines between the members due to the geometric shapes of the members. These gaps/voids may need to be filled in order to increase the strength of the bond. A composite filler member is applied to fill the gaps. The composite filler member can include various shapes that match the gaps and are often referred to as noodles.

Composite fillers members may be formed using a variety of different methods. However, the conventional techniques may have undesirable manufacturing costs, undesirable manufacturing times, or undesirable structural performance. One issue with existing composite fillers is the inability to tailor the construction to have a desired stiffness. Existing composite filler members, such as a uni-noodle or laminated noodle design, may not meet the structural requirements for their specific application.

Therefore, there is a need for materials and processes that result in a composite filler member with a tailored stiffness that meets the structural requirements for a given application. The processes should be designed to manufacture the composite filler members in a low-cost and timely manner.

### SUMMARY

One aspect is directed to a method of making a composite filler member from a composite blank that comprises elongated fibers and resin. The method comprises: cutting the elongated fibers within the composite blank and forming a plurality of shorter discrete fiber sections; forming the composite blank into a corrugated configuration comprising a plurality of overlapping layers that each comprise the fiber sections; and forming the composite blank that is in the corrugated configuration into a final shape.

In another aspect, the method further comprises cutting the elongated fibers in the discrete fiber sections based on at least one of a desired strength and a desired stiffness.

In another aspect, the method further comprises maintaining one or more of the elongated fibers in the composite blank in an uncut configuration.

In another aspect, cutting the elongated fibers within the composite blank comprises passing the composite blank along a roll cutting die and cutting the elongated fibers into the fiber sections.

In another aspect, the method further comprises cutting the composite blank from a larger composite sheet prior to cutting the elongated fibers.

In another aspect, the method further comprises cutting the elongated fibers and obtaining a predetermined density of cuts of the elongated fibers within the composite blank.

In another aspect, the method further comprises cutting the elongated fibers and reducing a stiffness of the composite blank.

In another aspect, the elongated fibers are unidirectional elongated fibers.

In another aspect, the method further comprises forming the composite blank into a triangular shape after forming the composite blank into the corrugated configuration.

In another aspect, the method further comprises heating the composite blank while shaping into the final shape.

In another aspect, the method further comprises inserting the composite filler member into a gap in an aircraft with the composite filler member comprising a sectional shape that matches a shape of the gap.

One aspect is directed to a method of making a composite blank for use with a composite filler member. The method comprises positioning the composite blank on a support surface with the composite blank being a sheet with elongated fibers and resin and with the elongated fibers aligned along a length of the composite blank and with the composite blank having an initial stiffness. The method also comprises cutting one or more of the elongated fibers within the composite blank and reducing the initial stiffness of the composite blank to a working stiffness.

In another aspect, the method further comprises moving the composite blank relative to a roll cutting die and cutting the portion of the elongated fibers with blades that extend outward from the roll cutting die.

In another aspect, the method further comprises cutting all of the elongated fibers within the composite blank with cuts in the elongated fibers being staggered to obtain at least one of a desired strength and a desired stiffness.

In another aspect, the method further comprises cutting the portion of the elongated fibers into different lengths within the composite blank.

One aspect is directed to a composite filler member comprising a composite blank comprising resin and unidirectional fibers that extend within the resin. The fibers comprise cut fiber sections and uncut fibers that comprise a longer length than the cut fiber sections. The composite blank is arranged in a corrugated configuration.

In another aspect, the uncut fibers extend along a length of the composite blank between a first end and a second end.

In another aspect, the composite filler member comprises a triangular shape.

In another aspect, the method further comprises folds in the composite blank with the folds being parallel with the unidirectional fibers.

In another aspect, the cut fiber sections comprise a variety of different lengths.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of an aircraft with a cut-away section illustrating stringers that extend within the interior of the wing.

FIG. 2 is an isometric view of a stringers that includes a composite filler member.

FIG. 3 is a perspective view of a composite filler member that includes elongated fibers that are cut into fiber sections.

FIG. 4 is a schematic plan view of a composite blank that includes resin and elongated fibers.

FIG. 5 is a schematic plan view of a composite blank that includes cut elongated fibers and resin.

FIG. 6 is a schematic diagram of a composite blank being passed along a roll cutting die to form cut elongated fibers.

FIG. 7 is a schematic diagram of a composite blank being fed into a corrugating machine.

FIG. 8 is a schematic diagram of a forming machine to form a composite blank with cut fibers into a desired shape.

FIG. 9 is a flowchart diagram illustrating a method of making a composite filler member.

FIG. 10 is a flowchart diagram illustrating a method of making a composite blank for use with a composite filler member.

### DETAILED DESCRIPTION

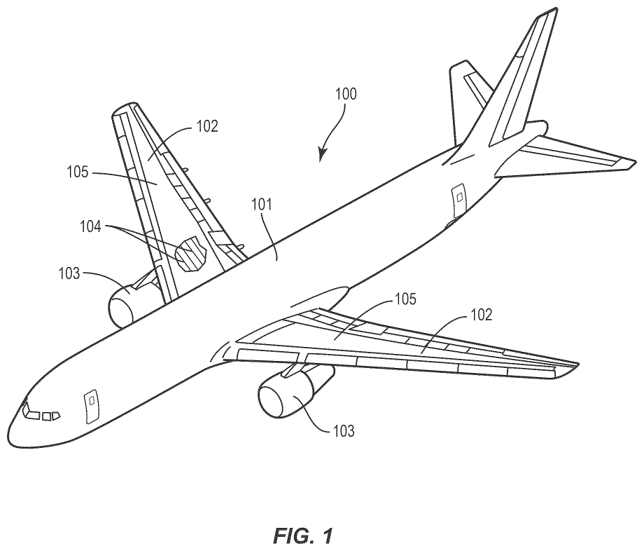

FIG. 1 illustrates an aircraft 100 configured to transport passengers and/or cargo. The aircraft 100 generally includes a fuselage 101 and wings 102. Engines 103 are attached to the wings 102. The aircraft 100 includes one or more structural members. For example, the wings 102 include stringers 104 that extend along the length of the wings 102. The stringers 104 provide structural support for the wings 102 and are covered by the skin 105.

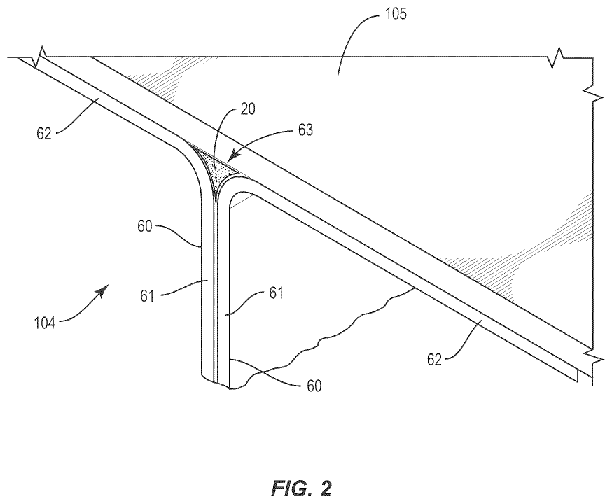

FIG. 2 illustrates a section of a stringer 104. The stringer 104 includes a pair of stiffeners 60 that each include a web 61 and a flange 62. FIG. 2 illustrates one example of a stringer 104 that has a substantially “T” shape. Other examples of stringers 104 can have different shapes and/or configurations such as but not limited to an “I” shape, and various blades and hats. In the examples of FIG. 2, the stiffeners 60 are arranged in a side-by-side configuration. In some examples, the webs 61 abut together with other examples including the webs spaced apart. The flanges 62 extend outward away from the webs 61 and contact against the skin 105. A gap 63 is formed between the stringer 104 and skin 105. The gap 63 has a substantially triangular shape due to the shapes of the stiffeners 60. A composite filler member 20 is mounted in and fills the gap 63. The composite filler member 20 is shaped to conform to the shape of the gap 63.

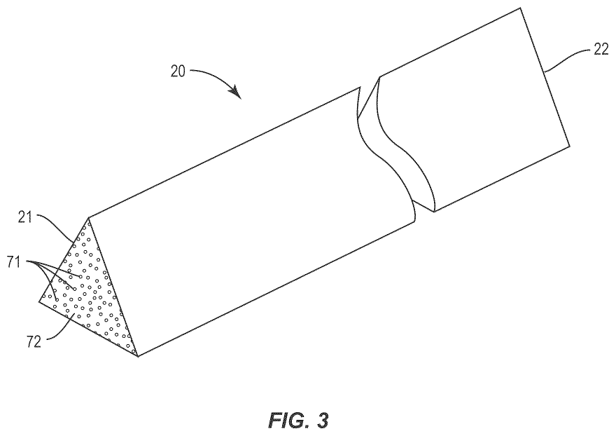

The composite filler member 20 is formed from a composite blank that is configured to have a predetermined stiffness. The predetermined stiffness may be a specific number or may fall within a range. FIG. 3 illustrates a composite filler member 20 that includes a first end 21 and opposing second end 22. A length is measured between the first end 21 and second end 22. The composite filler member 20 is shaped to match the corresponding gap 63 where it is contained. The shape can vary with examples including but not limited to triangular as illustrated in FIG. 3, oval, polygonal, and circular. The composite filler member 20 is formed from a composite material that includes fibers 71 that are embedded in a resin 72. Some or all the fibers 71 are cut at one or more places along the length. The cut fibers 71 enable the composite filler member 20 to have the desired stiffness.

In some examples as illustrated in FIG. 2, the composite filler member 20 is shaped to correspond to the shape of the gap 63. In other examples, the composite filler member 20 includes other shapes that are different than the gap 63. The composite filler member 20 can include different sectional sizes. In some examples as illustrated in FIG. 2, the composite filler member 20 fills substantially the entirety of the gap 63. In other examples, the composite filler member 20 is slightly larger than the gap 63 and compressed to fit. Likewise, the length of the composite filler member 20 can correspond to the length of the gap 63 or can be shorter than the length of the gap 63.

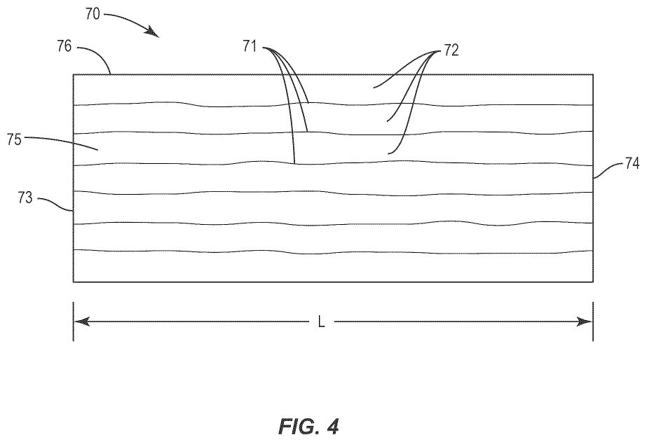

The composite filler member 20 is formed from a composite blank 70 as illustrated in FIG. 4. The composite blank 70 includes fibers 71 embedded within resin 72. The composite blank 70 can include a variety of different shapes and sizes, including a sheet with a substantially rectangular shape as illustrated in FIG. 4. A length L is measured between a first end 73 and an opposing second end 74. The composite blank 70 has a relatively narrow thickness measured between opposing faces 75, 76 and various widths measured across the length.

The fibers 71 are arranged in a unidirectional manner that extend lengthwise within the composite blank 70. In some examples, the fibers 71 are aligned substantially parallel to each other in the lengthwise direction. In some examples, some of the fibers 71 are aligned at different orientations and overlap within the blank 70. The fibers 71 can include different lengths. In some examples, each of the fibers 71 extend the entire length L with other examples including each of the fibers 71 having a shorter length L. Still other examples include the different fibers 71 having different lengths.

The fibers 71 can be formed from a variety of materials, including but not limited to aramids, polyolefins, metal, glass, carbon, boron, ceramic, mineral, and combinations. The resin 72 can be formed from a variety of substances, including but not limited to acrylics, fluorocarbons, polyamides (PA), polyethylenes (PE) such as polyethylene terephthalate (PET), polyesters, polypropylenes (PP), polycarbonates (PC), polyurethanes (PU), polyetheretherketones (PEEK), polyetherketoneketones (PEKK), polyetherimides (PEI), and other material compositions. In some examples, the composite blank 70 includes fibers 71 that are pre-impregnated with a thermoset or thermoplastic matrix resin (e.g., prepreg).

The composite blank 70 can include a variety of thicknesses. Examples include but are not limited to thicknesses of between about 0.0025-0.0175 inches. In some examples, the composite blank 70 is a single layer that includes fibers 71 and resin 72.

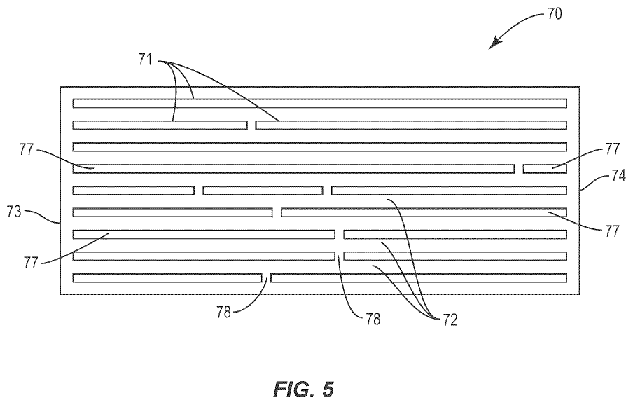

The composite blank 70 is processed by cutting the fibers 71 to reduce the stiffness to a desired lesser amount. FIG. 5 schematically illustrates a composite blank 70 that includes fibers 71 aligned in a unidirectional direction along the length and extending between the first and second ends 73, 74. A portion of the fibers 71 include cuts 78 that divide the fibers 71 into two or more sections 77 along the length of the composite blank 70. The different sections 77 can include the same or different lengths. In some examples, each of the fibers 71 is cut within the composite blank 70. In other examples, one or more of the fibers 71 remain uncut. In the example of FIG. 5, a limited number of fibers 71 include cuts 78 with a remainder being uncut. The number of fibers 71 that are cut and the size and number of sections 77 will vary depending upon the desired stiffness. The cuts 78 can be in one or more different orientations. Example orientations include cuts 78 that substantially perpendicular to the length of the fibers 71 and cuts 78 that are made transverse to the fibers 71. The cuts 78 can include various lengths depending upon the tool used to cut the fiber 71.

The fibers 71 are cut into discrete lengths based on the desired strength. The density of the cuts 78 in the composite blank 70 can vary with the density of cuts in the fibers 71 based on the desired strength. The fibers 71 within the composite blank 70 include different numbers of cuts 78 ranging from fibers 71 with no cuts 78 to fibers 71 with multiple cuts 78. In some examples, the cuts 78 within the different fibers 71 are spaced at different lengths along the composite blank 70 to achieve the desired strength. In some examples, the cuts 78 are staggered across the length of the composite blank 70 to provide for the desired strength.

In some examples, the entire composite blank 70 is incorporated into the composite filler member 20. In other examples, smaller strips are cut from the larger composite blank 70 with one or more of the strips being incorporated into the composite filler member 20.

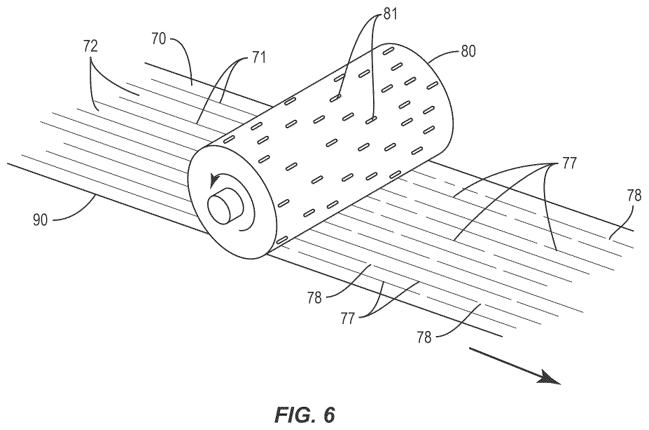

The fibers 71 within the composite blank 70 can be cut in various manners. FIG. 6 illustrates an example in which the composite blank 70 is positioned on a support surface 90, such as a table or cutting machine surface. The composite blank 70 is passed across a roll cutting die 80. The roll cutting die 80 has a cylindrical body with blades 81 spaced about the surface. The roll cutting die 80 rotates and blades 81 that extend outward from the body cut the fibers 71 into the fiber sections 77. The number and spacing of the blades 81 result in the number and sizing of the fiber sections 77.

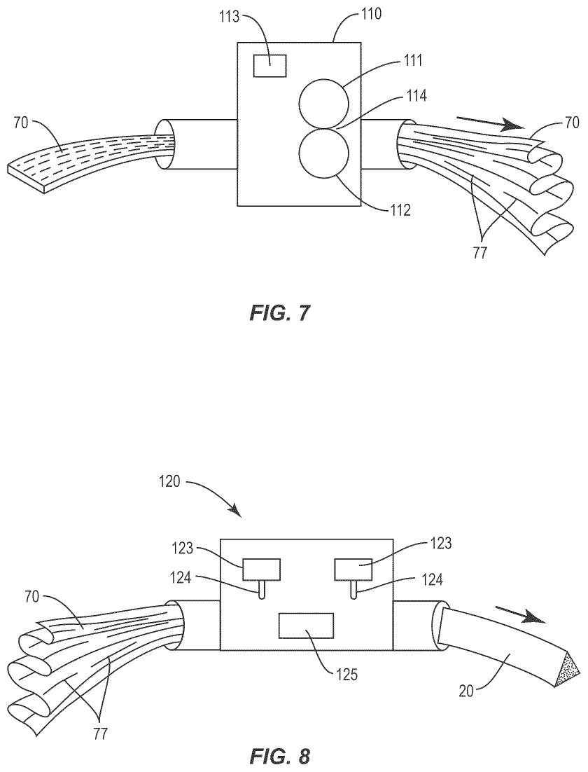

The composite blank 70 with the cut sections 77 is then corrugated or rolled to include multiple layers in an overlapping configuration. FIG. 7 illustrates a composite blank 70 being fed through a forming machine 110. The forming machine 110 includes rollers 111, 112 that are rotated by a motor assembly 113. Orifices 114 are formed between the surfaces of the rollers 111, 112 at the contact point of the rollers 111, 112. The composite blank 70 is fed into the forming machine 110 and into contact with one or both rollers 111, 112. As the rollers 111, 112 rotate, friction between the sides of the orifices 114 and the composite blank 70 draws the composite blank 70 into the forming machine 110. The composite blank 70 is compacted within the orifices 114 as it passes between the rollers 111, 112. The composite filler member 20 is output from the forming machine 110 and includes a corrugated configuration.

In some examples, the composite filler member 20 has the desired shape after exiting the forming machine 110. In other examples, the corrugated composite blank 70 goes through one or more additional forming processes to reach the desired shape. FIG. 8 schematically illustrates a shaping machine 120 that includes one or more actuators 123 configured to move dies 124 into contact with the corrugated composite blank 70. The dies 124 are shaped to form the corrugated composite blank 70 into the desired final shape. The actuators 123 and dies 124 can be positioned at various orientations to contact against and shape the corrugated composite blank 70 as needed to form the final shape. The actuators 123 are configured to apply a range of pressures to the dies 124 to enable the shaping. In some examples, a heater 125 elevates the temperature of the corrugated composite blank 70 to enable the shaping.

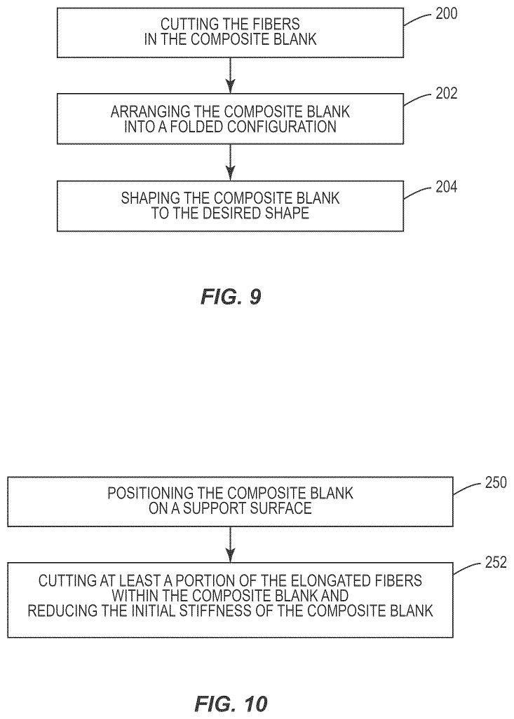

FIG. 9 illustrates a method of forming the composite filler member 20. Some or all of the elongated fibers 71 are cut within the composite blank 70 (block 200). This cutting causes the composite blank 70 to have the desired stiffness. The composite blank 70 with the cut fibers 71 is arranged into a folded configuration that has the fibers 71 aligned in a lengthwise direction (block 202). The composite blank 70 is shaped into the desired shape (block 204). In some examples, the folding and shaping of occurs in the same process, such as within the forming machine 110 of FIG. 7. Within the process, these steps may occur simultaneously or sequentially. In other examples, the folding and shaping occur in different processes, such as folding in a first machine/process and shaping in a separate second machine/process.

In some examples, the process is directed to forming the composite blank 70 with a reduced stiffness. This composite blank 70 can then be later processed as necessary. FIG. 10 illustrates a method of making a composite blank 70 for use with a composite filler member 20. The method includes positioning the composite blank 70 on a support surface 90 (block 250). In some examples, the composite blank 70 is in the shape of a sheet with a relatively large length and width and a narrow thickness. The composite blank 70 includes elongated fibers 71 and resin 72 with the elongated fibers 71 aligned along a length of the composite blank 70 and with the composite blank 70 having an initial stiffness. The method further includes cutting at least a portion of the elongated fibers 71 within the composite blank 70 and reducing the initial stiffness of the composite blank 70 to a working stiffness (block 252). The working stiffness is less than the initial stiffness and can vary depending upon the context of use.

This illustration of aircraft 100 is provided for purposes of illustrating one environment in which a composite filler member 20 may be implemented. The illustration of aircraft 100 in FIG. 1 is not meant to imply architectural limitations to the manner in which different illustrative examples may be implemented. For example, aircraft 100 is shown as a commercial passenger aircraft. The different illustrative embodiments may be applied to other types of aircraft, such as private passenger aircraft, a rotorcraft, unmanned aircraft, manned spacecraft, unmanned spacecraft, manned rotorcraft, unmanned rotorcraft, satellites, rockets, missiles, manned terrestrial aircraft, unmanned terrestrial aircraft, manned surface water borne aircraft, unmanned surface water borne aircraft, manned sub-surface water borne aircraft, unmanned sub-surface water borne aircraft, and combinations thereof.

By the term “substantially” with reference to the various aspects, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of making a composite filler member from a composite blank with the composite blank comprising elongated fibers and resin, the method comprising:
cutting the elongated fibers within the composite blank and forming a plurality of shorter discrete fiber sections;
forming the composite blank into a corrugated configuration comprising a plurality of overlapping layers that each comprise the fiber sections; and
forming the composite blank that is in the corrugated configuration into a final shape.

2. The method of claim 1, further comprising cutting the elongated fibers in the discrete fiber sections based on at least one of a desired strength and a desired stiffness.

3. The method of claim 2, further comprising maintaining one or more of the elongated fibers in the composite blank in an uncut configuration.

4. The method of claim 1, wherein cutting the elongated fibers within the composite blank comprises passing the composite blank along a roll cutting die and cutting the elongated fibers into the fiber sections.

5. The method of claim 1, further comprising cutting the composite blank from a larger composite sheet prior to cutting the elongated fibers.

6. The method of claim 1, further comprising cutting the elongated fibers and obtaining a predetermined density of cuts of the elongated fibers within the composite blank.

7. The method of claim 1, further comprising cutting the elongated fibers and reducing a stiffness of the composite blank.

8. The method of claim 1, wherein the elongated fibers are unidirectional elongated fibers.

9. The method of claim 1, further comprising forming the composite blank into a triangular shape after forming the composite blank into the corrugated configuration.

10. The method of claim 1, further comprising heating the composite blank while shaping into the final shape.

11. The method of claim 1, further comprising inserting the composite filler member into a gap in an aircraft with the composite filler member comprising a sectional shape that matches a shape of the gap.

12. A method of making a composite blank for use with a composite filler member, the method comprising:
positioning the composite blank on a support surface with the composite blank being a sheet with elongated fibers and resin, the elongated fibers aligned along a length of the composite blank and with the composite blank having an initial stiffness; and
cutting one or more of the elongated fibers within the composite blank and reducing the initial stiffness of the composite blank to a working stiffness.

13. The method of claim 12, further comprising moving the composite blank relative to a roll cutting die and cutting the elongated fibers with blades that extend outward from the roll cutting die.

14. The method of claim 12, further comprising cutting all of the elongated fibers within the composite blank with cuts in the elongated fibers being staggered to obtain at least one of a desired strength and a desired stiffness.

15. The method of claim 12, further comprising cutting the portion of the elongated fibers into different lengths within the composite blank.

16. A composite filler member comprising:
a composite blank comprising:
resin; and
unidirectional fibers that extend within the resin, the fibers comprising:
cut fiber sections; and
uncut fibers that comprise a longer length than the cut fiber sections; and
wherein the composite blank is arranged in a corrugated configuration.

17. The composite filler member of claim 16, wherein the uncut fibers extend along a length of the composite blank between a first end and a second end.

18. The composite filler member of claim 16, wherein the composite filler member comprises a triangular shape.

19. The composite filler member of claim 16, further comprising folds in the composite blank with the folds being parallel with the unidirectional fibers.

20. The composite filler member of claim 16, wherein the cut fiber sections comprise a variety of different lengths.
